(19) United States
(12) Patent Application Publication
(10) Pub. No.: US 2011/0195183 A1
(43) Pub. Date: Aug. 11, 2011

(54) SPIN COATER AND METHOD FOR SPIN COATING

(75) Inventors: Naoaki YAMASHITA, Kamisato (JP); Kyoichi MORI, Kamisato (JP); Takayuki ISHIGURO, Kamisato (JP); Noritake SHIZAWA, Kamisato (JP); Shinjiro ISHII, Kamisato (JP); Masashi AOKI, Kamisato (JP)

(73) Assignee: HITACHI HIGH-TECHNOLOGIES CORPORATION, Tokyo (JP)

(21) Appl. No.: 13/021,858

(22) Filed: Feb. 7, 2011

(30) Foreign Application Priority Data
Feb. 8, 2010 (JP) 2010-025119

(51) Int. Cl. B05D 1/40; B05C 5/00

(52) U.S. Cl. 427/240; 118/321

(57) ABSTRACT

There is provided a method for spin coating, by which a resist is coated on a surface of a circular disc with a hole formed in its center. A method for spin coating coats a film-forming material discharged from a nozzle to an upper surface of a circular disc substrate with a through hole formed in a center while rotating the substrate. At an initial discharging stage where a discharge amount fluctuates, an inner diameter center of the nozzle is located at an initial discharge radius position apart from a position corresponding to a coat boundary of the disc substrate at an outer radial side. At a subsequent stage of stabilized discharging amount, the inner diameter center of the nozzle is moved from the initial discharge radius position to a stabilized discharge radius position around the coat boundary to further discharge the film-forming material.

### BACKGROUND

The present invention relates to a method for spin coating, by which a resist is coated on a surface of a circular disc with a hole formed in its center. More specifically, the present invention relates to a spin coater and a method for spin coating for uniformly coating the resist on the surface of the circular disc with the hole formed in its center like a discrete track medium for performing the application which microfabricates the circular disc surface using a nanoimprint device for forming a microstructure on a surface of a transcribed body.

Accompanied with outstanding sophistication of various types of information equipment such as a computer, data size of the information handled by the user has been increasing to accomplish the unit region from giga to tera. Under the aforementioned environment, the demand of the semiconductor device as a data storage/reproduction device or a memory with further higher recording density has been growing.

It is necessary to establish further finer microfabrication engineering for increasing the recording density. The generally employed optical lithography method using the exposure process allows a large area to be microfabricated at a time. However, the aforementioned method provides no resolution with the wavelength equal to or shorter than that of light. Accordingly, the method is not suitable for performing the microfabrication with the wavelength equal to or shorter than that of light (for example, 100 nm or shorter). The exposure technique using electron, X-ray, or ion line may be employed as the technique for processing the microstructure with the wavelength equal to or shorter than that of light. Unlike one-shot exposure method using such a light source as i-line and excima laser, the time for patterning (exposure) executed by an electron patterning device will be prolonged as the increase in number of patterns to be formed with the electron. The higher the recording density becomes, the longer the time for forming the microfabrication pattern becomes, thus considerably deteriorating manufacturing throughput. Meanwhile, the one-shot graphic irradiation method for collectively irradiating electrons to a combination of various types of masks has been developed for accelerating pattern formation performed by the electron patterning device. The electron patterning device using the one-shot graphic irradiation method is enlarged, and requires the mechanism for controlling the mask position with even higher accuracy. This may increase the cost of the patterning device by itself, resulting in the high media manufacturing cost.

As the process for microfabrication with the wavelength equal to or shorter than that of light, a method using the print technique instead of the generally employed exposure technique has been proposed. For example, U.S. Pat. No. 5,772,905A discloses the “nanoimprint lithography (NIL) technique”. The nanoimprint lithography (NIL) technique presses an original plate (mold) on which a predetermined pattern has been microfabricated against a substrate to which the resist is coated through the technique for microfabrication with the wavelength equal to or shorter than that of light under pressure, for example, electron exposure technique so as to transfer the microfabrication pattern of the mold to the resist layer of the substrate. The use of only the mold allows the device equivalent to a generally employed printer to realize mass production of the replica without necessarily requiring the expensive exposure device. Compared with the electron exposure technique, the aforementioned technique markedly improves throughput, and largely reduces manufacturing costs. The device intended to be used for the aforementioned object is called a “microstructure transcriptional device” or “imprint device”.

In the case where the thermoplastic resin is used as the resist for the nanoimprint lithography (NIL) technique, the transfer is performed by increasing the material temperature to reach the glass transition temperature (Tg) or higher under the pressure. This method is called “thermal transfer” method. The thermal transfer method has an advantage that the general-purpose resin is usable extensively so long as it exhibits thermoplastic property. On the contrary, in the case where the photosensitive resin is used as the resist, the transfer is performed using the photocurable resin which is cured when it is exposed to light such as ultraviolet rays. This method is called the “optical transfer” method.

The nanoimprint processing method of optical transfer type requires the use of special photocurable resin. However, such method has an advantage that the dimensional error of the finished product owing to thermal expansion of the transfer printing plate or the printed member can be made smaller compared with the method of thermal transfer type. The method allows the device to eliminate the use of a heating mechanism, and auxiliary devices for increasing the temperature, controlling the temperature, and cooling. Additionally, the imprint (microstructure transcriptional) device has the advantage that the design required to cope with the thermal strain such as heat insulation is no longer necessary.

US Patent Publication No. 2008/0042319A1 discloses an example of the imprint (microstructure transfer) device of optical transfer type. The disclosed device presses the stamper which allows UV transmission against the disc on which the photocurable resin (resist) is coated to receive irradiation of the UV light from above. After the resist is cured, the stamper is removed so that the resist microstructure is formed on the disc surface. The predetermined microstructure pattern is formed on the surface of the stamper, which is pressed against the transcriptional substrate to have the pattern transferred.

The resist has to be coated on the disc surface while having the coated thickness as even as possible for forming the resist microstructure with high accuracy. There are various types of methods for coating the resist to the disc surface, for example, dip coating, spray coating, electrostatic coating, brush coater, roll coater, meniscus coater, ink jet, die coat, spin coat and the like. The spin coat is generally selected in view of uniformity of the coat film thickness, reproducibility, mass productivity, and work efficiency.

### SUMMARY

The method for spin coating drops or discharges the resist onto the center of the rotating work, and spreads the resist over an entire surface of the work using centrifugal force so as to make the film thickness even. As the disc has a hole formed in its center, the method for discharging the resist to the center so as to be spread over the entire surface cannot be employed. The coating is then tried using the method for sealing the center hole with the cap so that the resist is dropped or discharged onto the center of the cap for spreading the resin to reach the circumference of the disc. With the aforementioned method, the discontinuous configuration such as stepped portion and gap between the cap and the disc adversely influences the process to deteriorate uniformity of the film thickness. Another method for discharging the resist at the radius position which is not in contact with the inner circumferential hole may be employed for spreading the resist toward the outer circumference. With the aforementioned method, however, the resist discharge positions form a circular shape rather than the single position. The coating may be influenced by accuracy of the resist discharging positions, and as a result, the uniformity of the film thickness is likely to be deteriorated especially at the inner circumferential portion.

It is an object of the present invention to provide a method for spin coating which coats the resist uniformly on the surface of the circular disc which has a hole formed in the center.

It is another object of the present invention to provide a spin coater used for performing the method for spin coating.

The present invention provides a method for spin coating, which coats a film-forming material discharged from a nozzle to an upper surface of a circular disc substrate with a through hole formed in a center while rotating the substrate. At an initial discharging stage where a discharge amount fluctuates, an inner diameter center of the nozzle is located at an initial discharge radius position apart from a position corresponding to a coat boundary of the disc substrate at an outer radial side. At a subsequent stage of stabilized discharging amount, the inner diameter center of the nozzle is moved from the initial discharge radius position to a stabilized discharge radius position around the coat boundary to further discharge the film-forming material.

The present invention provides a spin coater including a rotary shaft for chucking a circular disc substrate with a through hole formed in the center at an upper end portion, a motor for rotating the rotary shaft, and a nozzle for discharging a film-forming material to an upper surface of the circular disc substrate. The nozzle is supported at a moving mechanism. A location of the nozzle is changeable in accordance with an initial discharging stage where a discharge amount of the film-forming material fluctuates and a stage where the discharge amount of the film-forming material is stabilized.

When discharging the film-forming material from the nozzle to the disc surface, fluctuation of the discharge amount is large at the initial discharging stage. As a result, the coat boundary has irregularity, thus failing to form the boundary concentric with respect to the rotation center of the disc. Accordingly the unstable centrifugal force around the boundary makes the coated film thickness uneven. With the method for spin coating according to the present invention, the nozzle is located to a position apart from the coat boundary at outer side at the initial discharging stage. The nozzle is displaced to a position around the coat boundary at the stabilized discharging stage where the discharge amount no longer fluctuates. The coat boundary becomes concentric with respect to the rotation center of the disc, thus making the centrifugal force stable at the boundary, resulting in even thickness of the coated film.

The generally employed spin coater is configured to fix the nozzle position when discharging the film-forming material, and accordingly, it fails to cope with fluctuation of the discharge amount of the film-forming material to the disc surface at the initial discharging stage. On the contrary, the spin coater according to the present invention allows the nozzle to be interlocked with the moving mechanism so that the nozzle position when discharging is changeable in accordance with the initial discharging stage and the stabilized discharging stage. The use of the spin coater with function for changing the nozzle position forms the coated film with even thickness.

These features and advantages of the invention will be apparent from the following more particular description of preferred embodiments of the invention, as illustrated in the accompanying drawings.

### BRIEF DESCRIPTION OF THE DRAWINGS

FIG. 1 illustrates an exemplary structure of a spin coater used for performing a method for spin coating according to the present invention;

FIG. 2 is a partially enlarged plan view of a circular disc substrate widely distributed as the recording medium for a hard disc;

FIG. 3 is an explanatory sectional view representing the state where the resist is discharged to the upper surface of the circular disc substrate using the method for spin coating according to the present invention;

FIG. 4 is a view representing a transient response characteristic of the resist discharge amount using the method for spin coating;

FIG. 5 is an explanatory plan view representing a state where a method for spin coating is performed to form the coat boundary by locating the nozzle at the fixed discharge radius position around the coat boundary using the method other than the one for spin coating according to the present invention;

FIG. 6 is an explanatory plan view representing a state where the method for spin coating according to the present invention is performed for coating the resist to form the coat boundary;

FIG. 7 is a view representing an optical inspection result with respect to uneven thickness of the spin coated disc surface according to a first embodiment; and

FIG. 8 is a view representing an optical inspection result with respect to the uneven thickness of the spin coated disc surface according to a first comparative example.

### DESCRIPTION OF THE PREFERRED EMBODIMENT

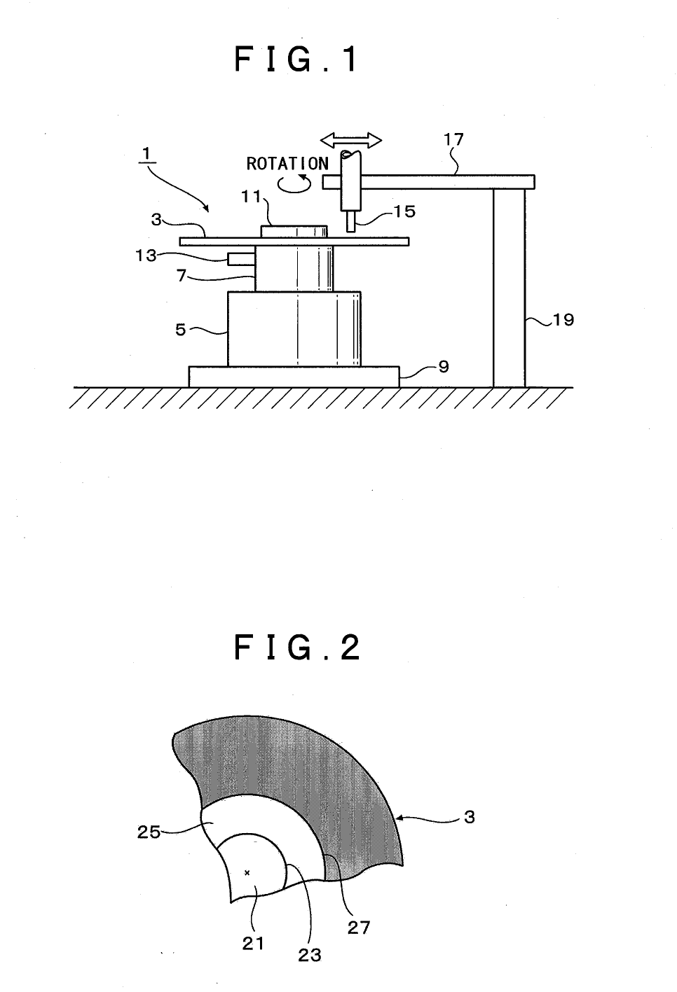

A preferred embodiment of the method for spin coating according to the present invention will be described referring to the drawings. FIG. 1 illustrates an exemplary structure of a spin coater used for performing the method for spin coating according to the present invention. A spin coater 1 according to the present invention includes a motor 5 for rotating a circular disc substrate 3. The motor 5 includes a rotary shaft 7. The motor 5 is mounted on a motor mount base 9. Referring to the drawing, the rotary shaft 7 protrudes outside the motor 5, and a center hole of the circular disc substrate 3 is engaged with a convex portion 11 at the upper end of the rotary shaft 7 while being held horizontally. The convex portion 11 is provided with a well-known member (not shown) for chucking the circular disc substrate 3. The disc chucking member serves to detachably engage the circular disc substrate 3 with the rotary shaft 7, and to rotate the disc substrate at a predetermined speed in a stable manner. The rotary shaft 7 may be provided with a tachometer 13 if necessary.

The most significant feature of the spin coater 1 according to the present invention is its ability to displace a dispenser nozzle 15 for discharging. The generally employed spin coater has a dispenser nozzle for discharging at the fixed position, which cannot be displaced. The spin coater 1 according to the present invention allows the dispenser nozzle 15 to be supported at a moving mechanism 17. The moving mechanism 17 is capable of moving the dispenser nozzle 15 in a radially inward direction or a radially outward direction with respect to the circular disc substrate 3. The moving mechanism 17 is supported at an appropriate support member 19 which stands on the mount base 9. A well-known microfabricating moving device, for example, a ball screw, a stepping motor and the like may be used as the moving mechanism 17.

FIG. 2 is a partially enlarged plan view of the circular disc substrate 3 widely distributed as the recording medium for a hard disc. The circular disc substrate 3 has a through hole 21 with a predetermined radius at its center (marked by x in the drawing) for allowing insertion of the rotary shaft such as the motor of the hard disc. When using the method for spin coating for discharging the resist to be circularly spread on the rotating disc 3, the film-forming material such as the resist is not coated on the region from an outer circumference 23 of the through hole 21 to the radially outward portion by a predetermined distance. A resulting uncoated region 25 is used for handling the vacuum chucked circular disc substrate 3. A coat boundary 27 with respect to the uncoated region 25 has to be concentric with respect to the rotation center (marked by x in the drawing) for realizing stable centrifugal force for spreading the resist.

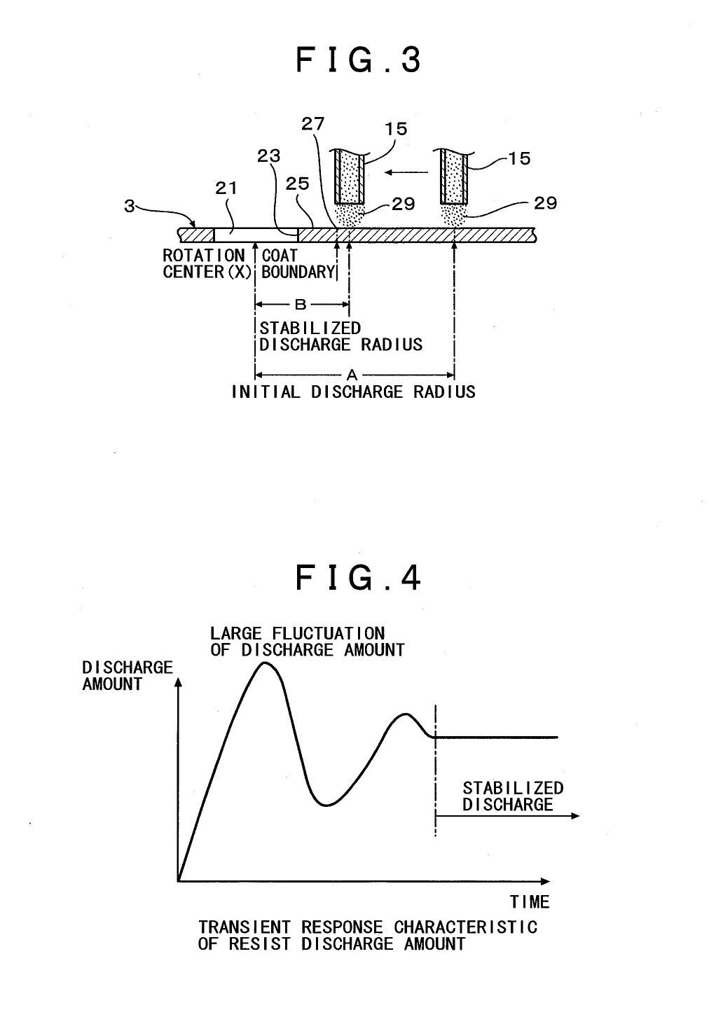

FIG. 3 is a sectional view representing the state where the resist is discharged from the nozzle 15 to the upper surface of the circular disc substrate 3 using the method for spin coating according to the present invention. The method for spin coating according to the present invention has a feature that a resist 29 is discharged to the upper surface of the circular disc substrate 3 from the nozzle 15 at a position apart from the coat boundary 27 at the outer circumferential side (initial discharge radius) at the initial discharging stage, and thereafter, the nozzle 15 at the outer circumference side is moved in the radial inward direction to the position just above the coat boundary 27 with respect to the uncoated region 25 (stabilized discharge radius) for further discharging the resist 29. The coat boundary 27 with respect to the uncoated region 25 becomes concentric with respect to the rotation center so that the centrifugal force of the coat boundary 27 is stabilized, resulting in the resist coated film with even thickness.

FIG. 4 represents a transient response characteristic of the discharge amount of the resist through the method for spin coating. At the initial stage, the resist 29 is discharged from the nozzle 15 to the upper surface of the circular disc substrate 3 in the form of a droplet with an outer diameter larger than the inner diameter of the nozzle 15 owing to the transient response of the resist discharge pressure and the surface tension of the resist. At the initial discharging stage, the discharge amount of the resist is the largest, and then decreased. It is increased again to reach the constant value in the stable state. The graph shows that a certain period of time is need from the start for stabilizing the discharge amount.

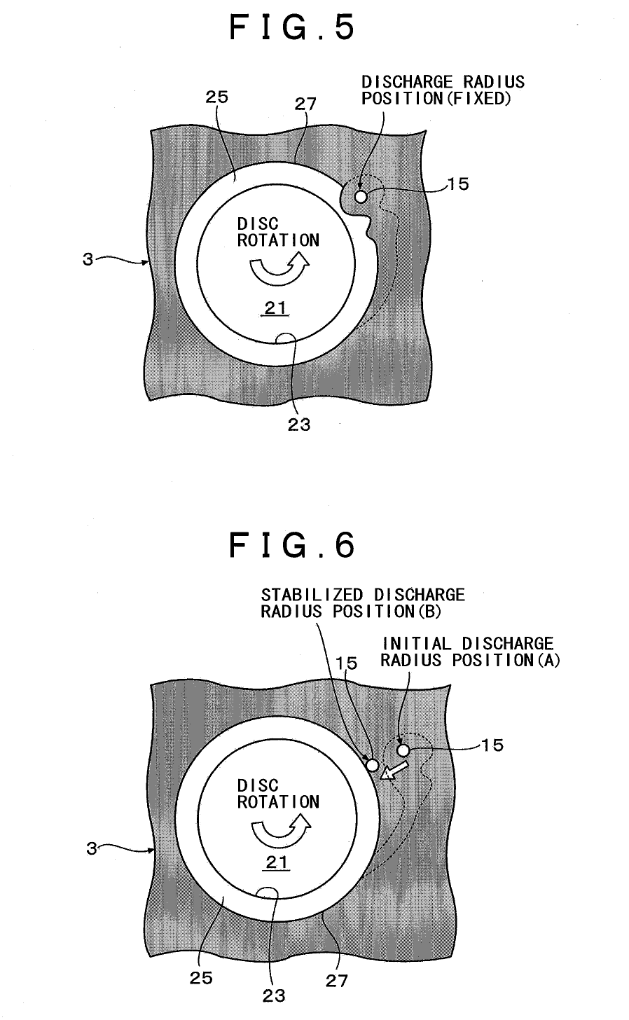

FIG. 5 is an explanatory plan view of a state where the coat boundary 27 is formed when the spin coating according to the method other than the present invention is performed by placing the nozzle 15 at the fixed discharge radius position around the coat boundary 27. When the nozzle 15 is located at the fixed discharge radius position around the coat boundary 27 to perform the spin coating, the contour of the coat boundary 27 has irregularity which reflects fluctuation of the discharge amount under the influence of a transient unstable discharge amount upon start of discharging. The coat boundary 27 does not become concentric. In the case where the spin coating is continuously performed while keeping the irregular portion in the contour of the coat boundary 27, the centrifugal force becomes unstable to cause the uneven coated disc surface, thus failing to obtain the resist coated film with even thickness.

FIG. 6 is an explanatory plan view of a state where the coat boundary 27 is formed when coating the resist through the method for spin coating according to the present invention. The method for spin coating according to the present invention locates the center of the inner diameter of the nozzle 15 at the position apart from the coat boundary 27 in the radial outward direction (initial discharge radius position A). When the resist 29 is discharged to the upper surface of the circular disc substrate 3 from the nozzle 15 at the position A, the discharge amount fluctuates as described referring to FIG. 4. In the method according to the present invention, however, the inner diameter center of the nozzle 15 is moved to the position near the coat boundary 27 (stabilized discharge radius position B) when the resist discharge amount is stabilized. At the position, the resist 29 is further discharged. The coat boundary 27 becomes completely concentric with respect to the rotation center, and the centrifugal force of the coat boundary 27 becomes stable. This makes it possible to provide the resist coated film with even thickness. A large amount of the resist discharged at a point around the initial discharge radius position A is uniformly spread through the spin coating to prevent generation of uneven thickness of the coated resist film.

The displacement (A-B) of the nozzle 15 in the method for spin coating according to the present invention varies in accordance with various factors such as the dispenser nozzle 15 for the use, the distance from the leading end of the nozzle 15 to the upper surface of the disc substrate 3, and viscosity and discharge amount of the resist 29. Generally, the displacement is in the range from 1.5 to 30 times larger than the inner radius of the nozzle 15 for the use. If the displacement (A-B) of the nozzle 15 is smaller than the value 1.5 times of size of the inner radius of the nozzle 15, the initial discharge radius position A is too close to the stabilized discharge radius position B. This may generate irregularity in the contour of the coat boundary 27 under the influence of fluctuation of the discharge amount at the initial discharging stage. Meanwhile, if the displacement (A-B) of the nozzle 15 exceeds the value 30 times larger than the size of the inner radius of the nozzle 15, the contour of the coat boundary 27 becomes concentric with respect to the rotation center. However, it is not preferable because the film-forming accuracy may be deteriorated or the resist cost may be increased owing to the increase in the coated amount of the resist to the disc substrate 3. For example, if the inner diameter of the nozzle 15 is 0.2 mm, it is preferable to set the displacement (A-B) of the nozzle 15 to the value of approximately 1 mm.

The method for spin coating according to the present invention moves the nozzle 15 from the initial discharge radius position A to the stabilized discharge radius position B. The time period taken from start of discharging the resist until start of movement of the nozzle to the stabilized discharge radius position B, that is, the time required for the stabilization of discharging varies in accordance with the factor such as the rotation speed of the circular disc substrate 3, the dispenser nozzle 15 for the use, and viscosity and discharge amount of the resist 29. Generally, the time period is approximately in the range from 0.1 to 5 seconds. If the time is shorter than 0.1 seconds, it is insufficient for stabilization of discharging. Meanwhile, if the time exceeds 5 seconds, it is excessively sufficient to stabilize the discharging, only prolonging the coating process period without providing the advantage. The optimum time period for stabilizing discharge of resist may be determined by performing the coating process in advance repeatedly. For example, under the condition where the discharge time at the initial discharge radius position A (stationary period at the position A) is set to be short, the time period until the coat irregularity occurs is measured by conducting the preliminary coating test so as to be determined as the time required from start to stabilization of discharging in the actual coating process.

Other condition preferable to be employed for performing the method for spin coating according to the present invention includes: (1) rotation speed at the initial discharge stage of the resist; (2) resist discharging pressure; and (3) distance from the leading end of the nozzle to the disc surface. Preferably, the rotation speed of the disc at the initial resist discharging stage is in the range from 300 rpm to 2000 rpm. If the rotation speed of the disc at the initial resist discharging stage is lower than 300 rpm, the resist spreads at low speeds. Accordingly, the resist solution retains to cause irregularity in the coat boundary 27. Meanwhile, if the rotation speed of the disc at the initial resist discharging stage exceeds 2000 rpm, the resist cannot be coated on the disc surface. Preferably, the resist discharging pressure as the second condition is in the range from 5 kPa to 50 kPa. If the resist discharging pressure is lower than 5 kPa, the discharge amount at the initial discharging stage becomes even more unstable. If the resist discharging pressure exceeds 50 kPa, the discharge amount is increased to fluctuate the resist discharge radius from the leading end of the nozzle to cause irregularity in the coat boundary 27. Preferably the distance from the leading end of the nozzle to the disc surface as the third condition is in the range from 1 mm to 5 mm. If the distance from the leading end of the nozzle and the disc surface is smaller than 1 mm, the resist droplet retained on the leading end of the nozzle may be in contact with the disc surface, thus causing uneven film thickness. Meanwhile, if the distance between the leading end of the nozzle and the disc surface exceeds 5 mm, the resist discharging position on the disc surface becomes unstable, thus causing irregularity in the coat boundary 27.

### First Embodiment

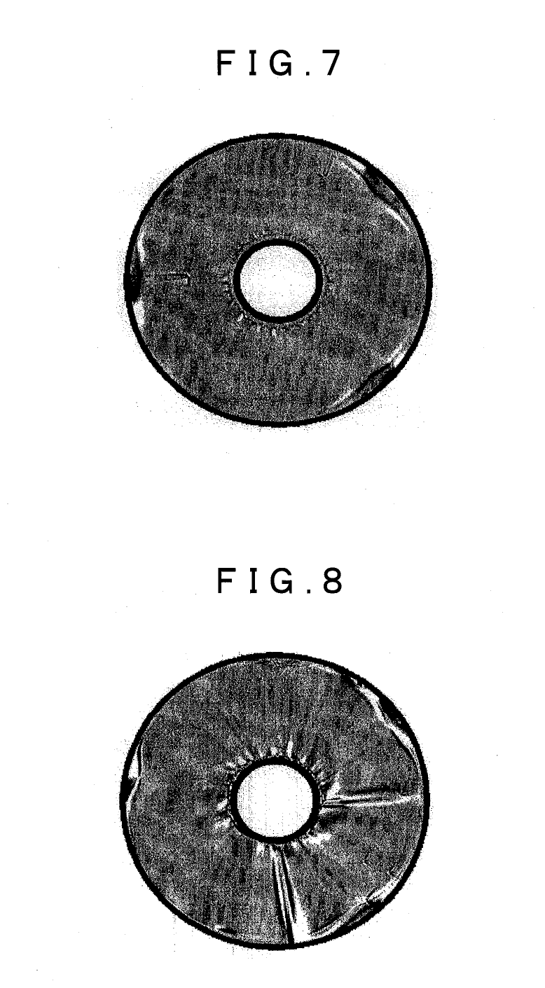

A silicon-based circular disc substrate with diameter of 50 mm, which has a center hole with inner diameter of 12 mm, is prepared as the disk substrate 3, and the substrate surface is washed with isopropyl alcohol. The dried substrate is set in a spin coater as shown in FIG. 1. A nozzle with inner diameter of 0.2 mm is used as the dispenser nozzle 15, and set in a moving mechanism driven by the stepping motor. The commercially available resist solution for spin coating, which is called “PAK-01” manufactured by TOYO GOSEI Co., Ltd. located in Chuo-ku, Tokyo is used as the resist solution. Under the condition where the rotation speed of the disc substrate 3 is set to 1400 rpm, the resist solution discharge pressure is set to 20 kPa, and the distance from the leading end of the nozzle 15 to the disc surface is set to 3 mm, the maximum diameter of the resist solution spread on the disc surface becomes 3 mm at the initial discharging stage. The diameter of the spread resist at the stabilized discharging stage becomes 2 mm. The center of the inner diameter of the nozzle is located at a position 9 mm apart from the rotation center of the circular disc substrate (initial discharge radius position A). The resist solution is discharged to the surface of the circular disc substrate from the nozzle while rotating the disc at 1400 rpm. After an elapse of 3 seconds from the start of discharging, the center of the inner diameter of the nozzle is moved to the position (stabilized discharge radius position B) 8 mm apart from the rotation center of the circular disc substrate. The resist is coated for 5 seconds while rotating the disc at 5000 rpm. It is then dried to form a resist film with thickness of 60 nm. Thereafter, uneven thickness of the resultant resist coated film is optically measured using an inspection device OSA (Optical Surface Analyzer) for measuring foreign matters and dent on the surface of the wafer substrate using ellipsometry measurement. The measurement result is shown in FIG. 7. The drawing clearly shows that the resist film is uniformly coated from the inner circumferential edge to the outer circumferential edge of the coat boundary.

### First Comparative Example

The spin coating is performed under the condition as described in the first embodiment except that the inner diameter center of the nozzle is initially located at a position 8 mm apart from a rotation center of the circular disc substrate (stabilized discharge radius position B). The resultant uneven thickness of the resist film coated on the disc substrate is optically measured. The measurement result is shown in FIG. 8. There are multiple radial lines from the inner circumferential edge to the outer circumferential edge of the coat boundary. This shows that the resist film has not been uniformly coated.

### Second Comparative Example

The spin coating is performed under the condition as described in the first embodiment except that the inner diameter center of the nozzle is displaced from a location (initial discharge radius position A) 9 mm apart from the rotation center of the circular disc substrate to a location (stabilized discharge radius position B) 8 mm apart from the rotation center of the circular disc substrate. The resultant uneven thickness of the resist film coated on the disc substrate is optically measured. There are radial lines which are the same as those shown in FIG. 8, showing that the resist film has not been uniformly coated. In spite of sufficient displacement, the desired effect of the present invention cannot be obtained if the time required for stabilizing the discharge is too short.

A preferred embodiment of the method for spin coating and a spin coater according to the present invention has been described. The present invention is not limited to the disclosed embodiment. The method for spin coating and the spin coater according to the present invention may be employed not only for performing the above-described nanoimprinting but also the resist coating for forming the wide variety of recording media such as magnetic recording medium and optical recording medium. The material to be coated through the spin coating is not limited to the resist, but other film-forming materials (for example, the film for forming an inter-layer insulating film, a planarization film, an oriented film and a protective firm) may also be coated using the method for spin coating and the spin coater according to the present invention.

The invention may be embodied in other specific forms without departing from the spirit or essential characteristics thereof. The present embodiment is therefore to be considered in all respects as illustrative and not restrictive, the scope of the invention being indicated by the appended claims, rather than by the foregoing description, and all changes which come within the meaning and range of equivalency of the claims are therefore intended to be embraced therein.

What is claimed is:

1. A method for spin coating, comprising the steps of:
positioning a substrate having a center hole on a rotary shaft by fitting the hole to the rotary shaft;
rotating the substrate by driving the rotary shaft;
locating a nozzle at an initial discharge position which is outer side of an innermost position in a radial direction of a film forming area on the substrate;
discharging a film-forming material from the nozzle onto a surface of the rotating substrate;
moving the nozzle near to the innermost position of the film forming area on the substrate while keep discharging the film-forming material onto the surface of the rotating substrate;
moving the nozzle to the outer side direction of the substrate while keep discharging the film-forming material onto the surface of the rotating substrate; and
stopping the movement of the nozzle and the discharge of the film-forming material;
stopping the rotation of the substrate by stopping the drive of the rotary shaft; and
unloading the substrate from the rotary shaft.

2. The method for spin coating according to claim 1, wherein a displacement from the initial discharge position to the position near to the innermost position is in a range from 1.5 to 30 times larger than an inner diameter of the nozzle.

3. The method for spin coating according to claim 1, wherein time taken from discharging the film-forming material to moving the nozzle near to the innermost position is in a range from 0.1 seconds to 5 seconds.

4. The method for spin coating according to claim 1,
wherein at the step of discharging the film-forming material, a rotation speed of the substrate is in a range from 300 rpm to 2000 rpm;
a discharging pressure of the film-forming material from the nozzle is in a range from 5 kPa to 50 kPa; and
a distance from a leading end of the nozzle to a surface of the substrate is in a range from 1 mm to 5 mm.

5. A spin coater comprising:
a rotary shaft for chucking a substrate with a hole formed in the center at an upper end portion;
a motor for rotating the rotary shaft;
a nozzle for discharging a film-forming material to an upper surface of the substrate; and
a moving mechanism for supporting the nozzle and changing a location of the nozzle along a radial direction of the rotary shaft.

6. The spin coater according to claim 5, wherein the moving mechanism change the location of the nozzle from outer side to inner side direction along the radial direction of the rotary shaft then inner side to outer side direction along the radial direction of the rotary shaft, a displacement of the nozzle from outer side to inner side direction along the radial direction of the rotary shaft is in a range from 1.5 to 30 times larger than an inner diameter of the nozzle.

7. The spin coater according to claim 5, wherein time taken for the displacement of the nozzle from outer side to inner side along the radial direction of the rotary shaft is in a range from 0.1 seconds to 5 seconds.

8. The spin coater according to claim 5,
wherein the motor rotates the rotary shaft at a rotation speed in a range from 300 rpm to 2000 rpm;
the nozzle discharges the film-forming material in a range from 5 kPa to 50 kPa; and
a distance from a leading end of the nozzle to a surface of the substrate is in a range from 1 mm to 5 mm.
